(19) United States
(12) Patent Application Publication
(10) Pub. No.: US 2024/0070767 A1
(43) Pub. Date: Feb. 29, 2024

(54) INFORMATION PROCESSING DEVICE AND INFORMATION PROCESSING METHOD

(71) Applicant: TOYOTA JIDOSHA KABUSHIKI KAISHA, Aichi-ken (JP)

(72) Inventors: Hiroyuki OKAWARA, Nagoya-shi (JP); Tomoko HARADA, Yokohama-shi (JP)

(21) Appl. No.: 18/332,768

(22) Filed: Jun. 12, 2023

(30) Foreign Application Priority Data
Aug. 25, 2022 (JP) 2022-134488

(51) Int. Cl. G06Q 30/0645

(52) U.S. Cl. CPC G06Q 30/0645

(57) ABSTRACT

In the information processing device according to the present disclosure, when the lease contract period of the new vehicle expires, the control unit calculates and outputs the settlement amount based on the first table. In the information processing device according to the present disclosure, when the lease contract period of the used vehicle expires, the control unit calculates and outputs the settlement amount based on the second table. The first table stores a first reduction value associated with the assessment for each pre-partitioned item relating to a defect in the vehicle. The second table stores, for each item that is the same as the first table, a second reduction value related to the assessment. Among the second reduction values stored in the second table, the second reduction value of the first item is set to a value smaller than the first reduction value.

### BACKGROUND

### 1. Technical Field

The present disclosure relates to an information processing device and an information processing method.

### 2. Description of Related Art

A technique is known in which a difference between a residual value set at the time of a lease contract and an actual assessed amount is settled collectively at the time of expiration of the lease contract period (see, for example, Japanese Unexamined Patent Application Publication No. 2015-102883 (JP 2015-102883 A)).

### SUMMARY

An object of the present disclosure is to provide a technique capable of improving user satisfaction with respect to an assessment at the time of expiration of a lease contract period.

One aspect of the present disclosure is an information processing device. The information processing device in that case, for example, includes: a first table storing a first reduction value related to an assessment for each pre-classified item related to a defect in a vehicle; a second table that is a table storing a second reduction value related to an assessment for each of the same items as the first table, in which the second reduction value for a first item that is an item related to a defect of a first degree in a first part is set to a value smaller than the first reduction value; and a control unit that may be configured to calculate and output a settlement amount based on the first table when a lease contract period of a new vehicle expires, and calculate and output a settlement amount based on the second table when a lease contract period of a used vehicle expires.

Another aspect of the present disclosure is an information processing method. The information processing method in that case, for example, may include calculating and outputting a settlement amount based on a first table when a lease contract period of a new vehicle expires, and calculating and outputting a settlement amount based on a second table when a lease contract period of a used vehicle expires, by a computer including the first table storing a first reduction value related to an assessment for each pre-classified item related to a defect in a vehicle, and the second table that is a table storing a second reduction value related to an assessment for each of the same items as the first table, in which the second reduction value for a first item that is an item related to a defect of a first degree in a first part is set to a value smaller than the first reduction value.

Another aspect of the present disclosure may be an information processing program for causing a computer to execute the above-described information processing method, or a non-transitory storage medium storing the information processing program in a form readable by a computer.

According to the present disclosure, it is possible to provide a technique capable of improving user satisfaction with respect to an assessment at the time of expiration of a lease contract period.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle leasing system;

FIG. 2 is a diagram illustrating an example of an evaluation item;

FIG. 3 is a diagram illustrating a hardware configuration example of each of a server and a facility terminal included in the vehicle leasing system;

FIG. 4 is a block diagram illustrating an example of a functional configuration of a server;

FIG. 5 is a diagram illustrating an exemplary second table; and

FIG. 6 is a flowchart illustrating an example of a processing routine executed in the server.

### DETAILED DESCRIPTION OF EMBODIMENTS

In the vehicle lease contract, a predicted value (residual value) of the vehicle evaluation value at the time of expiration of the lease contract period is set. The fee paid by the user during the lease contract period is determined based on the difference between the value of the vehicle at the start of the lease contract period and the residual value. Further, at the time of expiration of the lease contract period, the vehicle is assessed on the basis of a subtraction value for each item classified in advance with respect to the defect of the vehicle. As used herein, the term “defect” refers to, for example, scratches, cracks, breakage, dents, deformation, defects, stains, fading of paint, peeling of paint, and the like on the exterior and interior. The “degree of defect” means the size (area) of the part where the defect occurred, the number of parts where the defect occurred, and the necessity of repair or replacement, etc. In the assessment of the vehicle, for example, the settlement amount is calculated by summing up the reduction amount of the items corresponding to the target vehicle among the items described above. The settlement amount is an amount charged to the user at the expiration of the lease contract period (at the time of return of the vehicle).

Here, when the object of the lease contract is a used car, it is difficult to accurately determine whether the defect in the vehicle occurred during the lease contract period or before the lease contract period. In particular, even when a vehicle is used according to an appropriate method of use, such as bumpers and interiors, it is difficult to determine the portion where scratches, stains, and the like are cumulatively easily attached. Therefore, when an assessment is made at the time of expiration of the lease term of the used vehicle under the same conditions as at the time of expiration of the lease term of the new vehicle, there is a possibility that the satisfaction level of the contract user with respect to the assessment result is low.

On the other hand, in the information processing device according to the present disclosure, when the lease contract period of the new vehicle expires, the control unit calculates the settlement amount based on the first table. Further, in the information processing device according to the present disclosure, when the lease contract period of the used vehicle expires, the control unit calculates the settlement amount based on the second table. The settlement amount calculated as described above is output by the control unit. In this case, the control unit may output the calculated settlement amount from an output device included in the information processing device. Alternatively, the control unit may transmit the calculated settlement amount to another device and output the settlement amount. The other device may be, for example, a terminal used by the target user of the lease contract. Alternatively, the other device may be a terminal used by a person who performs a settlement operation related to the settlement amount.

The first table in the present disclosure stores a first reduction value associated with an assessment for each pre-partitioned item related to a vehicle defect. Defects subject to “pre-classified items” referred to herein are defects that can be visually checked for their existence and degree. The defects are, for example, scratches, cracks, breaks, dents, deformations, defects, stains, color fading of paint, and peeling of paint on parts such as exterior panels, window glasses, mirrors, lights, bumpers, wheels, and interiors.

The second table in the present disclosure stores, for each item that is the same as the first table, the second reduction value related to the assessment. However, for at least the first item (item relating to a first degree of defect in the first part), the second reduction value of the second table is set to a value lower than the first reduction value of the first table. The “first part” is, for example, a part where scratches, stains, and the like are cumulatively easily attached even in a process of using the vehicle according to an appropriate use method, such as a bumper and an interior. A “first degree of defect” is a defect that does not require repair or replacement. A “first degree of defect” is, for example, a scratch and/or dirt that may cumulatively occur in the course of use of the vehicle according to the proper method of use. For items other than the first item, the second reduction value may be set to the same value as the first reduction value. Alternatively, for items other than the first item, the second reduction value may be set to a value lower than the first reduction value.

According to the information processing device of the present disclosure, the vehicle can be assessed using a table in which at least the reduction value of the first item is different between when the lease contract period of the new vehicle expires and when the lease contract period of the used vehicle expires. Accordingly, in a case where the object of the lease contract is a used vehicle, the reduction value for at least the first degree of defect in the first part can be made smaller than in a case where the object of the lease contract is a new vehicle. In other words, in the case where the object of the lease contract is a used vehicle, it is possible to suppress the reduction value regarding the defect of the part where the scratch, the dirt, or the like is likely to be cumulatively attached at least in the course of use of the vehicle as compared with the case where the object of the lease contract is a new vehicle. As a result, it is possible to prevent the settlement amount from becoming higher due to a defect that may have occurred before the lease contract period of the used car. Therefore, it is possible to improve the user satisfaction with respect to the assessment at the time of expiration of the lease contract period of the used vehicle.

The information processing device according to the present disclosure is, for example, a computer operated by a provider of a lease service of a vehicle. The control unit according to the present disclosure is, for example, a processor such as a Central Processing Unit (CPU) or a Digital Signal Processor (DSP) included in a computer.

### Embodiment

Hereinafter, an embodiment of the present disclosure will be described with reference to the drawings. The configurations and the like described in the following embodiments are not intended to limit the technical scope of the present disclosure only thereto unless otherwise specified. In the present embodiment, an example in which the information processing device according to the present disclosure is applied to a vehicle leasing system will be described.

### Overview of Vehicle Leasing System

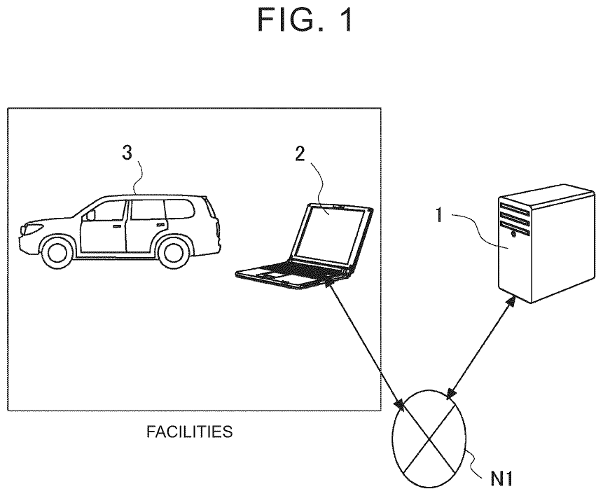

FIG. 1 is a diagram illustrating an outline of a vehicle leasing system according to the present embodiment. The vehicle leasing system according to the present embodiment is a system for providing a user with a leasing service of the vehicle 3. As illustrated in FIG. 1, the vehicle leasing system includes a server 1 and a facility terminal 2. The facility terminal 2 is a terminal used in a facility that manages the vehicle 3 to be leased. The “facility” referred to here is a place where the vehicle 3 is lent and returned, such as, for example, a leaser, an automobile dealer, an auction hall, or the like.

The servers 1 and the facility terminals 2 are connected to a network N1. The servers 1 and the facility terminals 2 can communicate with each other via a network N1. The network N1 is, for example, a public network such as the Internet, a physical or virtual dedicated line, or a Local Area Network (LAN. The network N1 may include a telephone communication network such as a mobile telephone or a radio communication network such as Wi-Fi.

The facility terminal 2 receives input of information on the vehicle 3 returned from the user upon expiration of the lease contract period (hereinafter, may be referred to as “first information”). The facility terminal 2 transmits the received first information to the server 1. The first information includes, for example, information for identifying whether the vehicle 3 subject to the lease contract is a new vehicle (whether the vehicle 3 is rented out in the state of a new vehicle) or a used vehicle (whether the vehicle 3 is rented out in the state of a used vehicle), information indicating the state of the vehicle 3, and the like. The input of the first information is performed by, for example, a staff member of the facility.

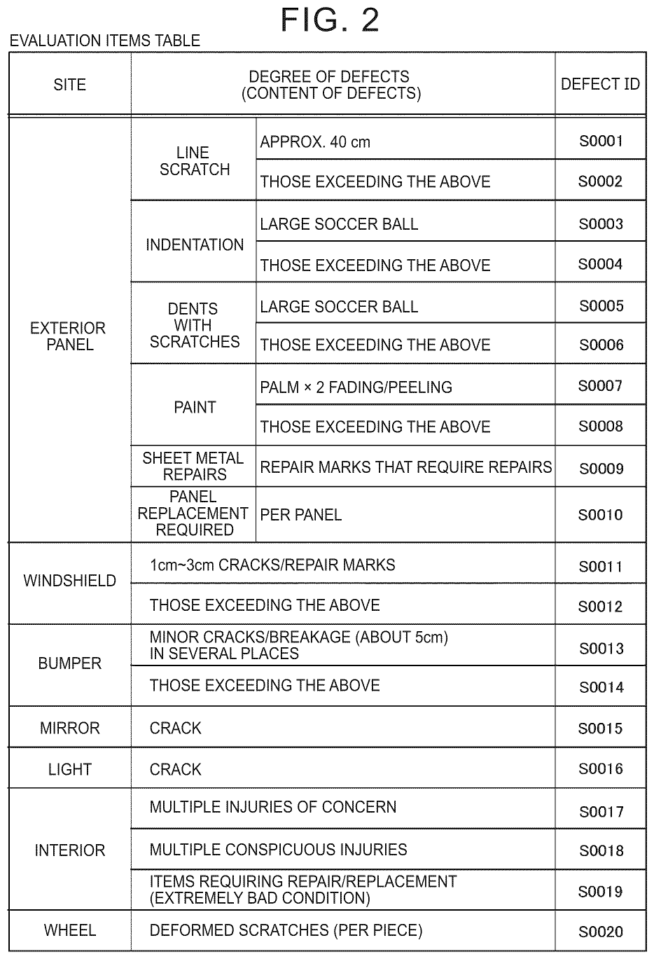

The information indicating the state of the vehicle 3 is, for example, information including all the identification information of the evaluation items corresponding to the vehicle 3 among a plurality of items (hereinafter, sometimes referred to as “evaluation items”) classified in advance with respect to the defect. Defects subject to evaluation items are defects whose existence and degree can be visually confirmed. As shown in FIG. 2, defects to be subjected to the evaluation items include, for example, line scratches of an exterior panel, dents of an exterior panel, dents with scratches of an exterior panel, color fading of a paint of an exterior panel, peeling of a paint of an exterior panel, a sheet metal repair mark of an exterior panel, cracks and/or repair marks of a windshield, bumper cracks and/or breaks, cracks of a mirror (door mirror), cracks of a light (front light, tail light), damage to an interior, scratches with deformation of a wheel, and the like. Among the above-mentioned defects, the evaluation items are classified according to the degree of defect (area, number, or necessity of repair and/or replacement, etc.) with respect to defects such as line scratches of the exterior panel, dents of the exterior panel, dents with scratches of the exterior panel, painting of the exterior panel, repair marks of the windshield, cracks and/or breakage of the bumper, and damage to the interior. The staff or the like of the facility inputs the identification information (defect ID in FIG. 2) of all the evaluation items corresponding to the vehicle 3 among the plurality of evaluation items as shown in FIG. 2 to the facility terminal 2.

Note that the evaluation items input to the facility terminal 2 by the staff of the facility are not limited to the example illustrated in FIG. 2. The evaluation items input to the facility terminal 2 by the staff of the facility may be evaluation items (defects) that can be confirmed in a short time by the staff of the facility.

The server 1 receives the first information from the facility terminal 2. The server 1 calculates the settlement amount based on the received first information. The settlement amount corresponds to the difference between the residual value set at the start of the lease contract period and the actual value at the expiration of the lease contract period. Such a settlement amount is charged to the user at the expiration of the lease contract period (at the time of returning the vehicle). In a case where a defect corresponding to the above-described evaluation item does not occur in the vehicle 3, the settlement amount is “0”.

The server 1 calculates the settlement amount based on the assessment table held by the server 1 and the information included in the first information. The assessment table is a table in which a subtraction value related to the assessment is determined for each of the plurality of evaluation items illustrated in FIG. 2. The assessment table in the present embodiment includes a first table and a second table. The first table is used to calculate the settlement amount when the object of the lease contract is a new vehicle. The second table is used to calculate the settlement amount when the object of the lease contract is a used car. The first table and the second table have different subtraction values for at least some of the evaluation items. Some evaluation items are, for example, items (first item) related to defects (first degree) to such an extent that repair and replacement of parts are not necessary in a part (first part) where, even when the vehicle 3 is used in an appropriate method of use, scratches and/or dirt are likely to be cumulatively attached in the course of use thereof (first part).

When the object of the lease contract is a used vehicle, an assessment is made using the second table, whereby the reduction value for the first degree of defect in the first part can be made smaller than in the case where the object of the lease contract is a new vehicle. In other words, in the case where the object of the lease contract is a used car, compared with the case where the object of the lease contract is a new car, it is possible to suppress the reduction value concerning the defect of the part where the scratch and/or the dirt are likely to accumulatively attach even in the use process by the proper use method to a small amount. As a result, it is possible to prevent the settlement amount from becoming higher due to a defect that may have occurred before the lease contract period of the used car.

The settlement amount calculated by the server 1 is transmitted from the server 1 to the facility terminal 2 through the network N1. The facility terminal 2 receives the settlement amount transmitted from the server 1. The facility terminal 2 outputs the received settlement amount. As a result, the staff of the facility or the like can present the settlement amount to the user or perform the settlement procedure of the settlement amount.

### Hardware Configuration of the Vehicle Leasing System

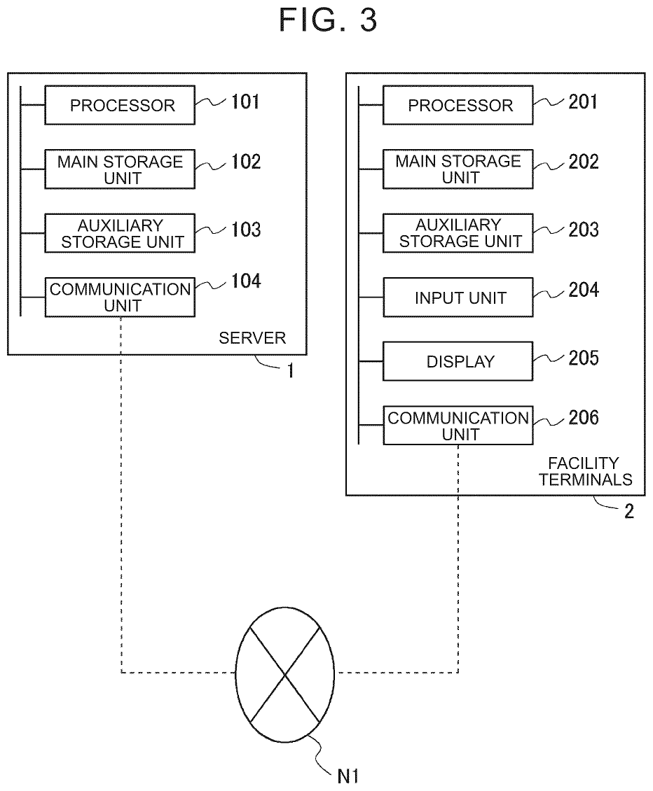

An example of the hardware configuration of the vehicle leasing system according to the present embodiment will be described with reference to FIG. 3. FIG. 3 is a diagram illustrating an example of a hardware configuration of each of the server 1 and the facility terminal 2 included in the vehicle leasing system illustrated in FIG. 1.

The servers 1 are computers such as PC or dedicated computers. The server 1 includes a processor 101, a main storage unit 102, an auxiliary storage unit 103, and a communication unit 104. The components are connected to each other by a bus. Note that the server 1 is an example of an “information processing device” according to the present disclosure. The processor 101 is an example of a “control unit” according to the present disclosure.

The processor 101 is, for example, Central Processing Unit (CPU) or Digital Signal Processor (DSP). The processor 101 controls the server 1 and performs calculation of various information processing. The main storage unit 102 is, for example, Random Access Memory (RAM) and Read Only Memory (ROM). The auxiliary storage unit 103 is, for example, an Erasable Programmable ROM (EPROM), a Hard Disk Drive, a removable medium, or the like. The auxiliary storage unit 103 stores Operating System (OS), various programs, various tables, and the like. The processor 101 loads the program stored in the auxiliary storage unit 103 into a work area of the main storage unit 102 and executes the program. Through the execution of this program, the respective constituent units and the like are controlled. As a result, the server 1 realizes a function that matches a predetermined purpose. The main storage unit 102 and the auxiliary storage unit 103 are computer-readable recording media. The server 1 may be a single computer. The server 1 may be a combination of a plurality of computers.

The communication unit 104 is a device that communicates with the facility terminal 2 through a network N1. The communication unit 104 is, for example, a LAN interface board and/or wireless communication circuitry for wireless communication. LAN interface board and/or the radio communication circuitry are connected to a network N1.

Next, the facility terminal 2 is, for example, a computer such as a smart phone, a mobile phone, a tablet terminal, a personal digital assistant, a wearable computer (smart watch or the like), or a PC. As illustrated in FIG. 3, the facility terminal 2 includes a processor 201, a main storage unit 202, an auxiliary storage unit 203, an input unit 204, a display 205, and a communication unit 206. The components are connected to each other by a bus. The processor 201, the main storage unit 202, and the auxiliary storage unit 203 of the facility terminal 2 are the same as those of the processor 101, the main storage unit 102, and the auxiliary storage unit 103 of the server 1. Therefore, description thereof will be omitted.

The input unit 204 is a device that receives an input operation performed by a staff of a facility or the like. For example, a touch panel, a mouse, a keyboard, a microphone, or the like. The display 205 is a device for presenting information to personnel of a facility, for example, a Liquid Crystal Display (LCD) or an Electro luminescence (EL). Note that the input unit 204 and the display 205 may be configured as a single touch panel display.

The communication unit 206 is a device for connecting the facility terminal 2 to a network N1. The communication unit 206 is a circuit for communicating with another device (for example, the server 1 or the like) over a network N1 using a telephone communication network such as a mobile communication service (for example, 6th Generation (6G), 5th Generation (5G), 4th Generation (4G), 3rd Generation (3G), or Long Term Evolution (LTE) or a radio communication network such as Wi-Fi (registered trademark). The communication unit 206 may be a LAN interface board connected to a wired network.

Note that the hardware configuration of the server 1 and the facility terminal 2 illustrated in FIG. 3 is an example. The hardware configuration of the server 1 and the facility terminal 2 is not limited to the hardware configuration illustrated in FIG. 3.

### Functional Configuration of the Server

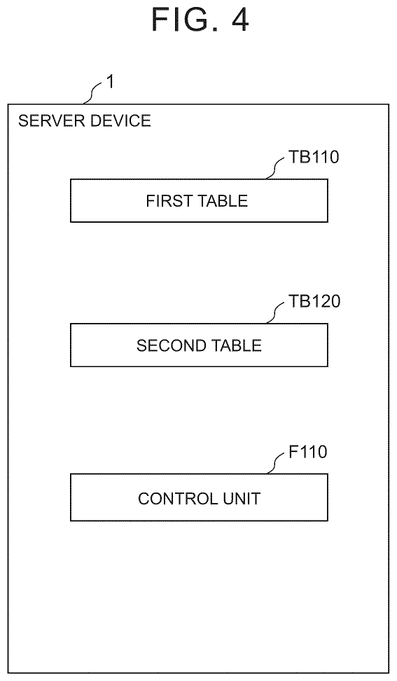

The functional configuration of the server 1 according to the present embodiment will be described with reference to FIG. 4. FIG. 4 is a block diagram illustrating an example of a functional configuration of the server 1. As illustrated in FIG. 4, the servers 1 of the present embodiment include a first table TB110, a second table TB120, and a control unit F110 as functional components thereof.

The first table TB110 and the second table TB120 are stored in the auxiliary storage unit 103 of the server 1. The first table TB110 is a table in which a subtraction value (first subtraction value) applied when the object of the lease contract is a new vehicle is stored for each evaluation item. The second table TB120 is a table in which a subtraction value (second subtraction value) applied when the object of the lease contract is a used vehicle is stored for each evaluation item. The evaluation items to be the target of the first reduction value stored in the first table TB110 and the evaluation items to be the target of the second reduction value stored in the second table TB120 are the same. Specifically, the evaluation items subject to the first reduction value and the second reduction value are similar to the evaluation items exemplified in FIG. 2 described above.

In the first table TB110 and the second table TB120, the first reduction value and the second reduction value in some evaluation items are different from each other. Some evaluation items are, for example, evaluation items (first item) corresponding to defects (first degree) that do not require repair or replacement of parts (first degree) with respect to a part (first part) that is likely to be cumulatively scratched and/or dirty in a use process conforming to an appropriate use method. In the present embodiment, as the first item, “slight crack/breakage (degree of 5 cm) in several places” in the bumper (evaluation item corresponding to the defect ID of S0013 in FIG. 2), a “plurality of damages to be worried” in the interior (evaluation item corresponding to the defect ID of S0017 in FIG. 2), and a “plurality of noticeable damages” in the interior (evaluation item corresponding to the defect ID of S0018 in FIG. 2) are exemplified. For the evaluation items other than the first item, the first reduction value and the second reduction value are set to the same value.

An exemplary second table TB120 according to the present embodiment will now be described with reference to FIG. 4. The parentheses in FIG. 4 add the first subtracted value of the first table TB110 for explanation. The second table TB120 stores a plurality of records as illustrated in FIG. 4. The plurality of records corresponds to each of the plurality of evaluation items illustrated in FIG. 2. The records have a defect ID field and a second reduction field.

In the defect ID field, identification information (defect ID) of the respective evaluation items is registered. The information registered in the defect ID field of FIG. 4 is information corresponding to the identification information (defect ID) of the evaluation items shown in FIG. 2. In the second reduction value field, the reduction value of each evaluation item is registered. The “reduction value” referred to here is, for example, an amount corresponding to a decrease in the market value of the vehicle 3 due to a defect in each evaluation item, and/or an amount determined based on expenses or the like caused by repair or replacement of a part where a defect in each evaluation item occurs.

In the present embodiment, the second reduction value corresponding to the evaluation item having S0013 defect ID (the “minor crack/breakage (degree of 5 cm)” in the bumper) is set to an amount lower than the first reduction value corresponding to the evaluation item in the first table TB110. In addition, the second reduction value corresponding to the evaluation item of which the defect ID is S0017 (a “plurality of damages to be worried” in the interior) is also set to an amount lower than the first reduction value corresponding to the evaluation item in the first table TB110. Further, the second reduction value corresponding to the evaluation item of which the defect ID is S0018 (“a plurality of conspicuous damages in the interior”) is also set to an amount lower than the first reduction value corresponding to the evaluation item in the first table TB110.

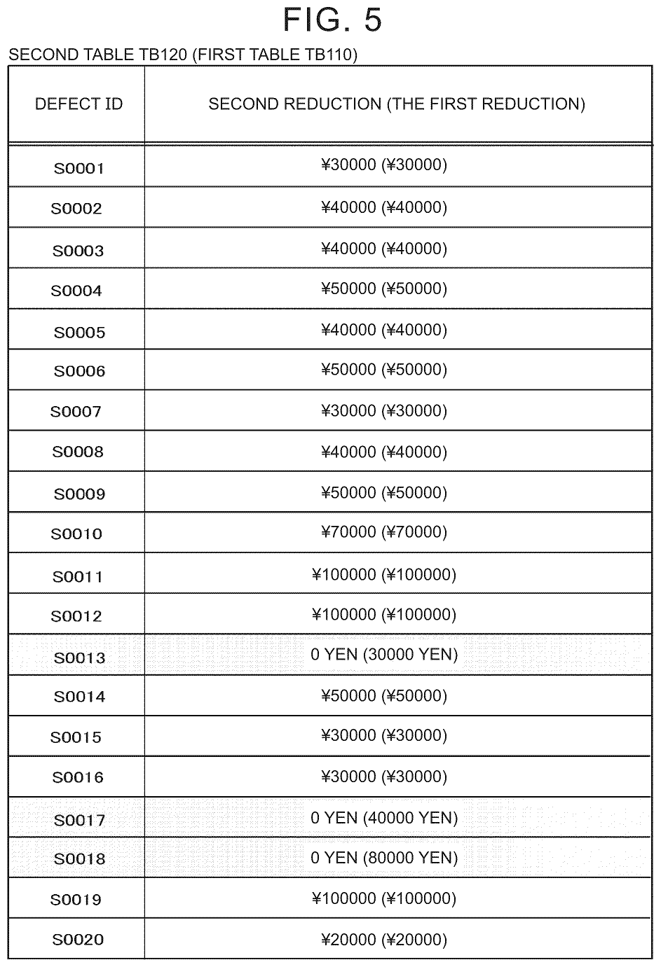

Incidentally, in the exemplary embodiment shown in FIG. 5, the second reduction value corresponding to each of the evaluation items having the defect ID of S0013, the evaluation item having the defect ID of S0017, and the evaluation item having the defect S0018 is set to “0 yen”. However, these second reductions may be less than the first reductions. For example, the second reduction value of each of the evaluation items having the defect ID of S0013, the evaluation item having the defect ID of S0017, and the evaluation item having the defect S0018 may be the half of the corresponding first reduction value.

In addition, the defects (evaluation items) subject to the first item are not limited to the defects illustrated in FIG. 5 in which the defect ID is S0013, the defects in which the defect ID is S0017, and the defects in which the defect S0018. The defect subject to the first item may be a defect in a portion which is likely to be cumulatively scratched and/or dirty in the course of use in accordance with the proper usage method. In other words, it may be a defect that is difficult to determine whether the defect is a defect that occurred before the lease contract period of the used car or a defect that occurred during the lease contract period of the used car. Such defects include, for example, line scratches or the like of the exterior panel near the door knob in the exterior panel.

It is also envisioned that the amount of decrease in market value and/or the cost incurred due to repair or replacement of a defect or the like may differ depending on the vehicle type, grade, optional equipment, or the like of the vehicle 3. Thus, each of the first table TB110 and the second table TB120 may include a plurality of tables for each vehicle type, grade, or optional equipment.

Here, the description of FIG. 4 is returned. In the control unit F110, the processor 101 of the server 1 loads the program of the auxiliary storage unit 103 into the main storage unit 102 and executes the program. Thus, the control unit F110 is a functional component to be realized. Note that the control unit F110 may be realized by hardware circuitry such as Application Specific Integrated Circuit (ASIC) or Field Programmable Gate Array (FPGA).

The control unit F110 of the server 1 calculates the settlement amount based on the first information provided from the facility terminal 2 and the first table TB110 or the second table TB120. Specifically, when the communication unit 104 of the server 1 receives the first information transmitted from the facility terminal 2, the control unit F110 determines, based on the information included in the first information (information identifying whether the vehicle 3 is a new vehicle or a used vehicle), whether the object of the lease contract is a new vehicle or a used vehicle.

When it is determined that the object of the leasing contract is a new vehicle, the control unit F110 calculates the settlement amount on the basis of information indicating the status of the vehicle 3 (identification information (defect ID) of all the evaluation items corresponding to the vehicle 3) and the first table TB110. The information indicating the state of the vehicle 3 is included in the first information. Specifically, the control unit F110 accesses the first table TB110 using the defect ID included in the first data as an argument. The control unit F110 specifies a record in which information matching the defect ID included in the first information is registered in the defect ID field. The control unit F110 reads the first reduction value registered in the first reduction value field of the identified record. The reading of the first subtraction value is performed for all defect ID contained in the first information. The control unit F110 sums the read first subtraction values to calculate the settlement amount.

When it is determined that the object of the leasing contract is a used vehicle, the control unit F110 accesses the second table TB120 with the defect ID included in the first information as an argument. The control unit F110 specifies a record in which information matching the defect ID included in the first information is registered in the defect ID field. The control unit F110 reads the second reduction value registered in the second reduction value field of the identified record. The reading of the second reduction is performed for all defect ID contained in the first data. The control unit F110 sums the read second subtraction values to calculate the settlement amount.

The control unit F110 transmits the settlement amount calculated as described above to the facility terminal 2 through the communication unit 104. The communication unit 206 of the facility terminal 2 receives the settlement amount transmitted from the communication unit 104 of the server 1. In this case, the processor 201 of the facility terminal 2 outputs the settlement amount received by the communication unit 206 to the display 205. As a result, the staff of the facility or the like can perform the billing procedure of the settlement amount to the user who has returned the vehicle 3.

The functional configuration of the server 1 is not limited to the example illustrated in FIG. 4. The functional configuration of the server 1 can be appropriately omitted, changed, or added to the functional components. In addition, any one of the functional components of the servers 1 or a part of the processes thereof may be executed by another computer connected to the network N1. For example, the processes included in the control unit F110 may be shared by a plurality of computers.

### Process Flow

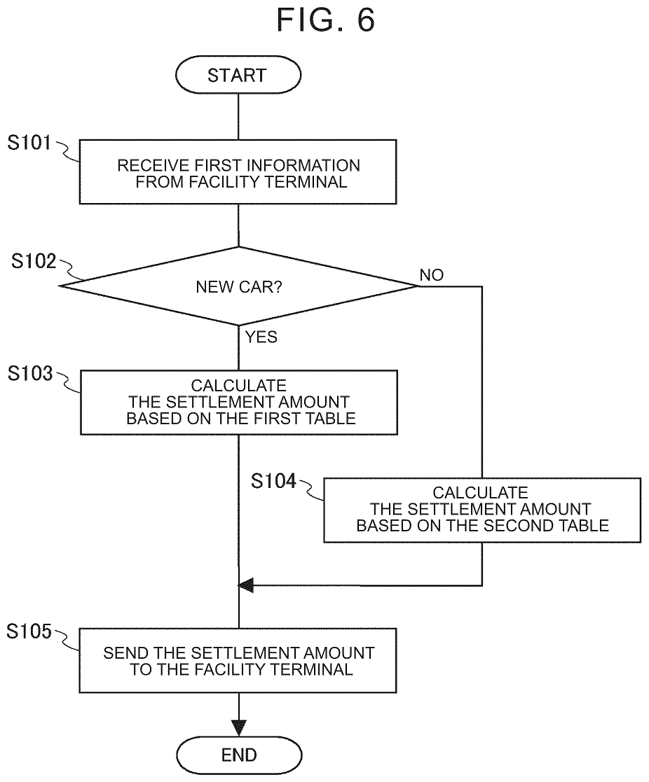

Next, a flow of processing performed by the server 1 will be described with reference to FIG. 6. FIG. 6 is a flowchart showing a processing routine executed by the server 1 triggered by the reception of the first information transmitted from the facility terminal 2. The execution subject of the processing routine of FIG. 6 is the processor 101 of the server 1. However, the functional components of the server 1 will be mainly described here.

In the process routine illustrated in FIG. 6, the control unit F110 of the server 1 receives, through the communication unit 104, the first information transmitted from the facility terminal 2 (S101). When the control unit F110 finishes executing S101 process, it executes S102 process.

In S102, the control unit F110 determines, based on the information included in the first information (information identifying whether the object of the lease contract is a new vehicle or a used vehicle), whether the vehicle 3 returned to the facility upon expiration of the lease contract term is a new vehicle. When the vehicles 3 returned to the facilities upon expiration of the leasing contract term are new vehicles (affirmative determination in S102), the control unit F110 executes S103 process. In addition, when the vehicles 3 returned to the facilities upon expiration of the leasing contract term are used vehicles (negative determination in S102), the control unit F110 executes S104 process.

In S103, the control unit F110 calculates the settlement amount based on the information indicating the status of the vehicle 3 and the first table TB110. The information indicating the state of the vehicle 3 is included in the first information. Specifically, the control unit F110 accesses the first table TB110 using the defect ID included in the first data as an argument. The control unit F110 specifies a record in which information matching the defect ID included in the first information is registered in the defect ID field. The control unit F110 reads the first reduction value registered in the first reduction value field of the identified record. When the control unit F110 completes the reading of the first reduction value for all the defect ID included in the first information, it sums the first reduction value read out. Thus, the control unit F110 calculates the settlement amount.

Further, in S104, the control unit F110 calculates the settlement amount based on the information indicating the status of the vehicle 3 and the second table TB120. The information indicating the state of the vehicle 3 is included in the first information. Specifically, the control unit F110 accesses the second table TB120 using the defect ID included in the first data as an argument. The control unit F110 specifies a record in which information matching the defect ID included in the first information is registered in the defect ID field. The control unit F110 reads the second reduction value registered in the second reduction value field of the identified record. When the control unit F110 completes the reading of the second reduction value for all the defect ID included in the first data, it sums the read second reduction value. Thus, the control unit F110 calculates the settlement amount.

When the control unit F110 finishes executing S103 or S104 process, it executes S105 process. In S105, the control unit F110 transmits the settlement amount calculated by S103 or S104 to the facility terminal 2 through the communication unit 104.

When the control unit F110 finishes executing S105 processing, the control unit F110 finishes executing this processing routine.

In S105 of FIG. 6, the settlement amount transmitted from the communication unit 104 of the server 1 is received by the communication unit 206 of the facility terminal 2. The received settlement amount is output from the communication unit 206 to the processor 201. The processor 201 outputs the settlement amount input from the communication unit 206 to the display 205. As a result, the staff of the facility or the like can present the settlement amount or charge the settlement amount to the user who has returned the vehicle 3.

### Operational Effect of Embodiment

In the present embodiment, the vehicle can be assessed using a table in which the reduction values of at least some of the evaluation items are different between the time when the lease contract period of the new vehicle expires and the time when the lease contract period of the used vehicle expires. As a result, in the case where the object of the lease contract is a used vehicle, it is possible to reduce the reduction value for the defect in the part where the scratch and/or the dirt are likely to accumulatively attach during the use process as compared with the case where the object of the lease contract is a new vehicle. As a result, it is possible to prevent the settlement amount from becoming higher due to a defect that may have occurred before the lease contract period of the used car. Therefore, it is possible to improve the user satisfaction with respect to the assessment at the time of expiration of the lease contract period of the used vehicle.

### Modified Examples

In the above-described FIG. 2, defects in which the defect ID is S0013, defects in which the defect ID is S0017, defects in which the defect S0018, and the like may accumulate as the number of leasing contracts for used vehicles increases. In other words, with regard to defects in ID of defects, defects in S0013, defects in S0017, and defects in S0018 of defects, the more the number of lease contracts for used vehicles becomes, the more difficult it is to distinguish between those that occurred before the lease contract period and those that occurred during the lease contract period. Therefore, the second reduction value corresponding to each of the evaluation items having a ID defect of S0013, the evaluation items having a S0017 defect ID, and the evaluation items having a S0018 defect ID may be set to a lower amount as the number of leasing contracts increases. In this case, a plurality of second table TB120 may be stored in the auxiliary storage unit 103 of the server 1 according to the number of leasing contracts.

The control unit F110 of the server 1 according to the present modification may calculate the settlement amount based on the second table TB120 corresponding to the number of lease contracts of the vehicle 3 when the information included in the first information (the information identifying whether the vehicle 3 returned to the facility with the expiration of the lease contract term is rented out in the state of the new vehicle or lent out in the state of the used vehicle) indicates the used vehicle. The information on the number of lease contracts of the vehicle 3 may be stored in a database constructed in the auxiliary storage unit 103 of the server 1. The information on the number of lease contracts of the vehicle 3 may be included in the first information and provided from the facility terminal 2.

According to the present modification, in the case where the vehicle 3 returned to the facility with the expiration of the lease contract period is rented in the state of the used vehicle, as the number of lease contracts of the vehicle 3 increases, the reduction value regarding the defect of the portion where the scratch, the dirt, or the like is likely to be cumulatively attached during the use process of the vehicle can be suppressed to be small. As a result, it is possible to more reliably improve the user's satisfaction with the assessment at the time of expiration of the lease contract period of the used vehicle.

### OTHER

The above-described embodiment and modifications are merely examples, and the present disclosure may be appropriately modified to be implemented without departing from the scope thereof. For example, the processing performed by the server 1 may be performed by the facility terminal 2. In this case, the facility terminal 2 corresponds to an “information processing device” according to the present disclosure.

Further, the processes described as being executed by one device may be shared and executed by a plurality of devices. Alternatively, the processes described as being executed by different devices may be executed by one device. For example, a part of the process executed by the server 1 may be executed by another device connected to the server 1 through a network N1. In a computer system, it is possible to flexibly change what kind of hardware configuration each function is realized.

Further, the present disclosure can also be realized by supplying a computer program implementing the functions described in the above embodiments to the server 1, and reading and executing the program by one or more processors included in the server 1. Such a computer program may be provided to the server 1 by a non-transitory computer readable storage medium connectable to a system bus of the server 1. The computer program may be provided to the server 1 via a network. Non-transitory computer-readable storage media store information, such as data and programs, by electrical, magnetic, optical, mechanical, or chemical action. A non-transitory computer-readable storage medium is a recording medium that can be read from a computer or the like. Such a recording medium may be, for example, any type of disk, such as a magnetic disk (floppy disk, hard disk drive (HDD), and the like) and an optical disk (CD-ROM, DVD disk, Blu-ray disk, and the like). The recording medium may be a medium such as a read-only memory (ROM), a random access memory (RAM), a EPROM, EEPROM, a magnetic card, a flash memory, an optical card, or a Solid State Drive (SSD).

What is claimed is:

1. An information processing device comprising:
a first table storing a first reduction value related to an assessment for each pre-classified item related to a defect in a vehicle;
a second table that is a table storing a second reduction value related to an assessment for each of the same items as the first table, in which the second reduction value for a first item that is an item related to a defect of a first degree in a first part is set to a value smaller than the first reduction value; and
a control unit configured to
calculate and output a settlement amount based on the first table when a lease contract period of a new vehicle expires, and
calculate and output a settlement amount based on the second table when a lease contract period of a used vehicle expires.

2. The information processing device according to claim 1, wherein:
the second table includes a plurality of tables in accordance with the number of lease contracts;
each of the tables stores the second reduction value for each of the same items as the first table, and the second reduction value of the first item decreases in the table corresponding to a case with a larger number of lease contracts; and
when the lease contract period of the used vehicle expires, the control unit calculates the settlement amount based on the table corresponding to the number of lease contracts of a target vehicle.

3. The information processing device according to claim 1, wherein:
the first part includes a bumper and/or an interior; and
the defect of the first degree is a defect that does not require repair or replacement.

4. The information processing device according to claim 1, wherein the control unit executes:
calculating a total value of the first reduction value or a total value of the second reduction value of all items corresponding to a vehicle for which a lease contract period has expired, among the items of the first table or the second table; and
outputting the total value of the first reduction value or the total value of the second reduction value as the settlement amount.

5. An information processing method comprising calculating and outputting a settlement amount based on a first table when a lease contract period of a new vehicle expires, and calculating and outputting a settlement amount based on a second table when a lease contract period of a used vehicle expires, by a computer including
the first table storing a first reduction value related to an assessment for each pre-classified item related to a defect in a vehicle, and
the second table that is a table storing a second reduction value related to an assessment for each of the same items as the first table, in which the second reduction value for a first item that is an item related to a defect of a first degree in a first part is set to a value smaller than the first reduction value.
